(19) United States
(12) Patent Application Publication
(10) Pub. No.: US 2026/0222090 A1
(43) Pub. Date: Jul. 30, 2026

(54) SELECTIVE MEASUREMENT FOR LAYER 1 (L1) AND LAYER (L2) MOBILITY

(71) Applicant: QUALCOMM Incorporated, San Diego, CA (US)

(72) Inventors: Fang YUAN, Beijing (CN); Yan ZHOU, San Diego, CA (US); Changhwan PARK, San Diego, CA (US)

(21) Appl. No.: 19/142,140

(22) PCT Filed: Feb. 24, 2023
(86) PCT No.: PCT/CN2023/078062

§ 371 Date: Jun. 20, 2025

(51) Int. Cl. H04B 17/318; H04W 36/00

(52) U.S. Cl. CPC H04B 17/328; H04W 36/0085

(57) ABSTRACT

Disclosed are systems and techniques for performing wireless communication. For example, a method for wireless communications at a network entity (e.g., a base station or portion thereof) may include determining cells in a triggering evaluation, determining a cell metric type, and determining a triggering condition. Based on the triggering condition, the user equipment may skip layer 1 (L1) measurements for one or more cells (e.g., that meet the triggering condition) or reduce L1 measurement frequency for the one or more cells.

### FIELD OF THE DISCLOSURE

Aspects of the present disclosure generally relate to wireless communication. According to some aspects, systems and techniques are described for selective measurement processes for Layer 1 (L1) and/or Layer 2 (L2) mobility, such as to reduce power consumption in user equipment.

### BACKGROUND OF THE DISCLOSURE

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one other example, a method for wireless communications performed at a user equipment (UE) is provided.

In some aspects, the techniques described herein relate to a method of wireless communications performed by a user equipment (UE), the method including: determining whether a relaxed measurement criterion for low mobility is satisfied based on at least one reference measurement of a cell and at least one current measurement of the cell; and based on the relaxed measurement criterion for low mobility being satisfied, performing a selective layer 1 (L1) measurement for the cell, the L1 measurement being associated with transitioning the UE from communicating with the cell to communicating with a candidate cell.

In some aspects, the techniques described herein relate to an apparatus for wireless communications, including: at least one memory; and at least one processor coupled to at least one memory and configured to: determine whether a relaxed measurement criterion for low mobility is satisfied based on at least one reference measurement of a cell and at least one current measurement of the cell; and based on the relaxed measurement criterion for low mobility being satisfied, perform a selective layer 1 (L1) measurement for the cell, the L1 measurement being associated with transitioning the apparatus from communicating with the cell to communicating with a candidate cell.

In some aspects, the techniques described herein relate to a non-transitory computer-readable medium having stored thereon instructions that, when executed by one or more processors, cause the one or more processors to be configured to: determine whether a relaxed measurement criterion for low mobility is satisfied based on at least one reference measurement of a cell and at least one current measurement of the cell; and based on the relaxed measurement criterion for low mobility being satisfied, perform a selective layer 1 (L1) measurement for the cell, the L1 measurement being associated with transitioning the apparatus from communicating with the cell to communicating with a candidate cell

In some aspects, the techniques described herein relate to an apparatus for wireless communications, the apparatus including: means for determining whether a relaxed measurement criterion for low mobility is satisfied based on at least one reference measurement of a cell and at least one current measurement of the cell; and means for, based on the relaxed measurement criterion for low mobility being satisfied, performing a selective layer 1 (L1) measurement for the cell, the L1 measurement being associated with transitioning the UE from communicating with the cell to communicating with a candidate cell.

In some aspects, the techniques described herein relate to a method of wireless communications performed by a user equipment (UE), the method including: determining whether a relaxed measurement criterion for a good cell-quality condition is satisfied based on a cell metric of a cell, a threshold associated with a downlink radio link quality, and an offset parameter; and based on the relaxed measurement criterion for the good cell-quality condition being satisfied, performing a selective layer 1 (L1) measurement for the cell, the L1 measurement being associated with transitioning the UE from communicating with the cell to communicating with a candidate cell.

In some aspects, the techniques described herein relate to an apparatus for wireless communications, including: at least one memory; and at least one processor coupled to at least one memory and configured to: determine whether a relaxed measurement criterion for a good cell-quality condition is satisfied based on a cell metric of a cell, a threshold associated with a downlink radio link quality, and an offset parameter; and based on the relaxed measurement criterion for the good cell-quality condition being satisfied, perform a selective layer 1 (L1) measurement for the cell, the L1 measurement being associated with transitioning the apparatus from communicating with the cell to communicating with a candidate cell.

In some aspects, the techniques described herein relate to a non-transitory computer-readable medium having stored thereon instructions that, when executed by one or more processors, cause the one or more processors to be configured to: determine whether a relaxed measurement criterion for a good cell-quality condition is satisfied based on a cell metric of a cell, a threshold associated with a downlink radio link quality, and an offset parameter; and based on the relaxed measurement criterion for the good cell-quality condition being satisfied, perform a selective layer 1 (L1) measurement for the cell, the L1 measurement being associated with transitioning the apparatus from communicating with the cell to communicating with a candidate cell.

In some aspects, the techniques described herein relate to an apparatus for wireless communications, the apparatus including: means for determining whether a relaxed measurement criterion for a good cell-quality condition is satisfied based on a cell metric of a cell, a threshold associated with a downlink radio link quality, and an offset parameter; and means for, based on the relaxed measurement criterion for the good cell-quality condition being satisfied, performing a selective layer 1 (L1) measurement for the cell, the L1 measurement being associated with transitioning the UF from communicating with the cell to communicating with a candidate cell.

In some aspects, the techniques described herein relate to a method of wireless communications performed by a user equipment (UE), the method including: determining whether a relaxed measurement criterion for a bad candidate-cell condition is satisfied based on comparing a threshold value to at least one of a cell metric of a candidate cell or a cell metric of a serving cell; and based on the relaxed measurement criterion for the bad candidate-cell condition being satisfied, performing a selective layer 1 (L1) measurement for at least one of the serving cell or the candidate cell, the L1 measurement being associated with transitioning the UE from communicating with the serving cell to communicating with at least one candidate cell.

In some aspects, the techniques described herein relate to an apparatus for wireless communication, including: at least one memory; and at least one processor coupled to at least one memory and configured to: determine whether a relaxed measurement criterion for a bad candidate-cell condition is satisfied based on comparing a threshold value to at least one of a cell metric of a candidate cell or a cell metric of a serving cell; and based on the relaxed measurement criterion for the bad candidate-cell condition being satisfied, perform a selective layer 1 (L1) measurement for at least one of the serving cell or the candidate cell, the L1 measurement being associated with transitioning the apparatus from communicating with the serving cell to communicating with at least one candidate cell.

In some aspects, the techniques described herein relate to a non-transitory computer-readable medium having stored thereon instructions that, when executed by one or more processors, cause the one or more processors to be configured to: determine whether a relaxed measurement criterion for a bad candidate-cell condition is satisfied based on comparing a threshold value to at least one of a cell metric of a candidate cell or a cell metric of a serving cell; and based on the relaxed measurement criterion for the bad candidate-cell condition being satisfied, perform a selective layer 1 (L1) measurement for at least one of the serving cell or the candidate cell, the L1 measurement being associated with transitioning the apparatus from communicating with the serving cell to communicating with at least one candidate cell.

In some aspects, the techniques described herein relate to an apparatus for wireless communications, the apparatus including: means for determining whether a relaxed measurement criterion for a bad candidate-cell condition is satisfied based on comparing a threshold value to at least one of a cell metric of a candidate cell or a cell metric of a serving cell; and means for, based on the relaxed measurement criterion for the bad candidate-cell condition being satisfied, performing a selective layer 1 (L1) measurement for at least one of the serving cell or the candidate cell, the L1 measurement being associated with transitioning the UE from communicating with the serving cell to communicating with at least one candidate cell.

In some aspects, the techniques described herein relate to a method of providing wireless communication performed by a user equipment (UE), the method including: determining one or more cells in a triggering evaluation; determining a cell metric type associated with the triggering evaluation; determining, according to the cell metric type, whether a triggering condition exists; and based on determining the triggering condition exists, performing a selective layer 1 (L1) measurement.

In some aspects, the techniques described herein relate to an apparatus for performing wireless communication, including: at least one memory; and at least one processor coupled to at least one memory and configured to: determine one or more cells in a triggering evaluation; determine a cell metric type associated with the triggering evaluation; determine, according to the cell metric type, whether a triggering condition exists; and based on determining the triggering condition exists, perform a selective layer 1 (L1) measurement.

In some aspects, the techniques described herein relate to a non-transitory computer-readable medium having stored thereon instructions that, when executed by one or more processors, cause the one or more processors to be configured to: determine one or more cells in a triggering evaluation; determine a cell metric type associated with the triggering evaluation; determine, according to the cell metric type, whether a triggering condition exists; and based on determining the triggering condition exists, perform a selective layer 1 (L1) measurement.

In some aspects, the techniques described herein relate to an apparatus for wireless communications, the apparatus including: means for determining one or more cells in a triggering evaluation; means for determining a cell metric type associated with the triggering evaluation; means for determining, according to the cell metric type, whether a triggering condition exists; and means for, based on determining the triggering condition exists, performing a selective layer 1 (L1) measurement.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 illustrates an example of a single primary serving cell (PCell) change without carrier aggregation and an example of a single special cell (SpCell) change without carrier aggregation, in accordance with some examples;

FIG. 6 illustrates an example of a PCell and secondary serving cell (SCell) change with carrier aggregation, in accordance with some examples;

FIG. 7 illustrates an example of cell group based selection, in accordance with some examples;

FIG. 8 illustrates an example of preconfigured candidate cells for L1/L2 based special cell (SpCell) change, in accordance with some examples;

FIG. 9 illustrates another example of preconfigured candidate cells for L1/L2 based SpCell selection, in accordance with some examples;

FIG. 10 illustrates an example of SpCell selection, in accordance with some examples;

FIG. 11 illustrates another example of SpCell selection, in accordance with some examples;

FIG. 12 illustrates another example of SpCell selection, in accordance with some examples;

FIG. 13A illustrates a flow diagram of an example process for selective measurement for Layer 1 and Layer 2 mobility, in accordance with some examples;

FIG. 13B illustrates a flow diagram of an example process for selective measurement for Layer 1 and Layer 2 mobility, in accordance with some examples;

FIG. 13C illustrates a flow diagram of an example process for selective measurement for Layer 1 and Layer 2 mobility, in accordance with some examples;

FIG. 14 illustrates a flow diagram of an example process for selective measurement for Layer 1 and Layer 2 mobility, in accordance with some examples; and

FIG. 15 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks are deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

A UE may transition from a serving cell to one or more candidate cells based on a triggering event. As disclosed below, there are a number of difference conditions which may cause the UE to transition from communicating with a serving cell to a candidate cell. Mobility of the UE is one of the factors, for example, which may cause the UE to transition away from a serving cell due to movement of the UE away from the serving cell to a candidate cell which is able to provide the wireless service. In some cases, the UE may use one or more layer 1 (L1) measurements (e.g., as a trigger) to evaluate whether to transition away from the serving cell and which cell should become the new serving cell. In 5G 3GPP Release 18, a serving cell or primary serving cell to a UE can be updated via layer 1/layer 2 signaling based on an L1 measurement. However, the L1 measurement only applies to the primary serving cell of the UE. Furthermore, in one aspect, there is only one metric that can be applied to the L1 measurement, which is a layer 3 reference signal received power (RSRP) only. Therefore, the triggering condition is very limited in terms of using the L1 measurement in a hand-off scenario.

As described in more detail below, apparatuses, electronic devices, methods (also referred to as processes), and computer-readable media (collectively referred to as “systems and techniques”) are described herein for signaling of cell and/or beam changes, such as Layer 1 (L1) and/or Layer 2 (L2) signaling of cell and/or beam changes. Alternatively or in addition, in some aspects, the systems and techniques can provide selective measurement for L1 and L2 mobility. For example, disclosed herein are various approaches for using more cells as part of a triggering evaluation (e.g., triggering whether to switch to one or more candidate cells). One or more cells beyond the primary serving cell can provide data for the triggering evaluation and different conditions can apply regarding which cells to use. Additional metrics can be used other than only layer 3 (L3) RSRP. For example, the systems and techniques can use fixed rules or dynamic rules for determining which cells to use for the triggering evaluation. Different combinations of cells can be determined for use in the evaluation.

In some aspects, additional metric types can be used in the triggering evaluation. For example, the additional metric types can include L3 cell quality, L3 synchronization signal-RSRP (SS-RSRP), L3 synchronized signal-signal to interference plus noise ratio (SS-SINR), beam or reference signal data, one or more reference signals in a cell, multiple transmission and reception point (mTRP) data, any combination thereof, and/or other metric types. Such data may be used to determine various conditions (e.g., a low mobility condition, a high-quality serving cell (or good serving cell) condition, a low-quality candidate cell (or bad serving cell) condition), such as based on various thresholds. The conditions can be compared to the thresholds to determine whether to perform a selective L1 measurement process, such as skipping the L1 measurement altogether or reducing an L1 measurement frequency to save on battery power. The systems and techniques can use various options for determining or performing a selective L1 measurement process, which can be based on a triggering evaluation.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAE) or drone, helicopter, airship, glider, etc.) and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

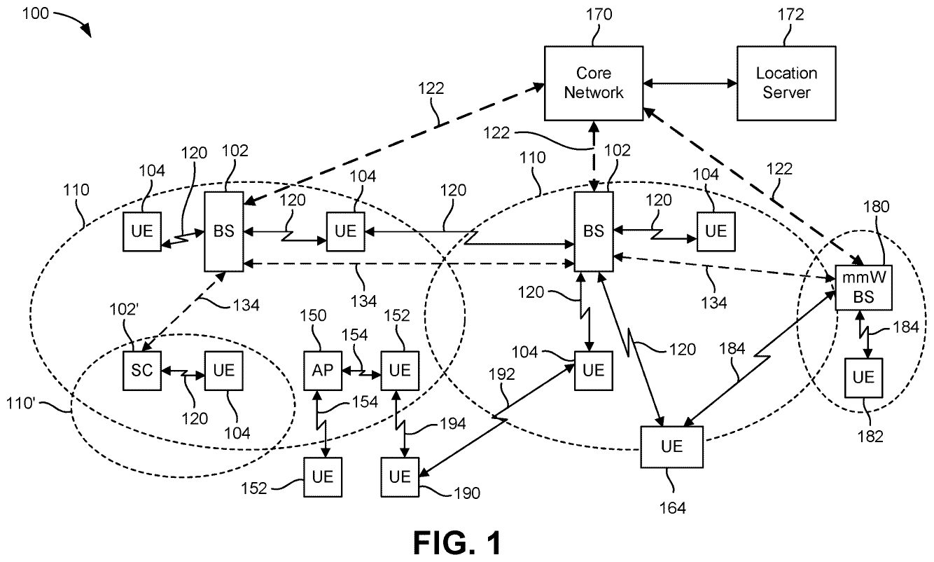

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identity or identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (e.g., SCells). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

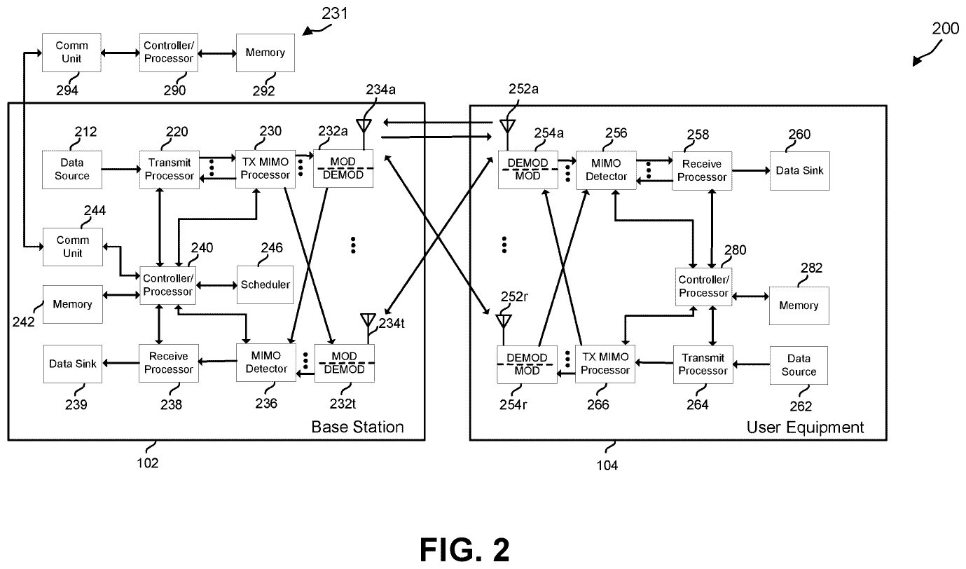

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UF 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

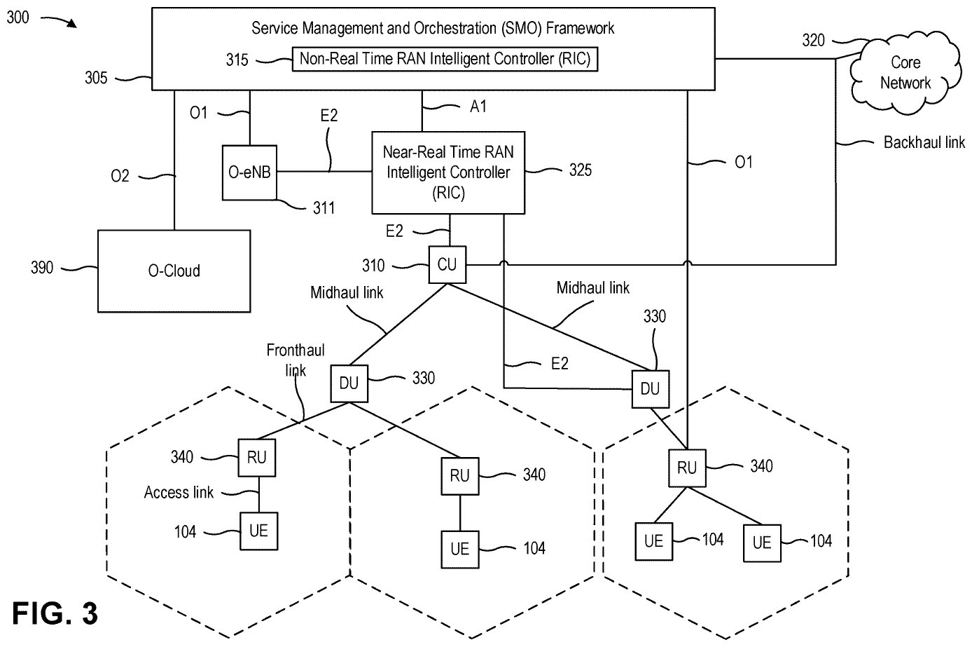

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

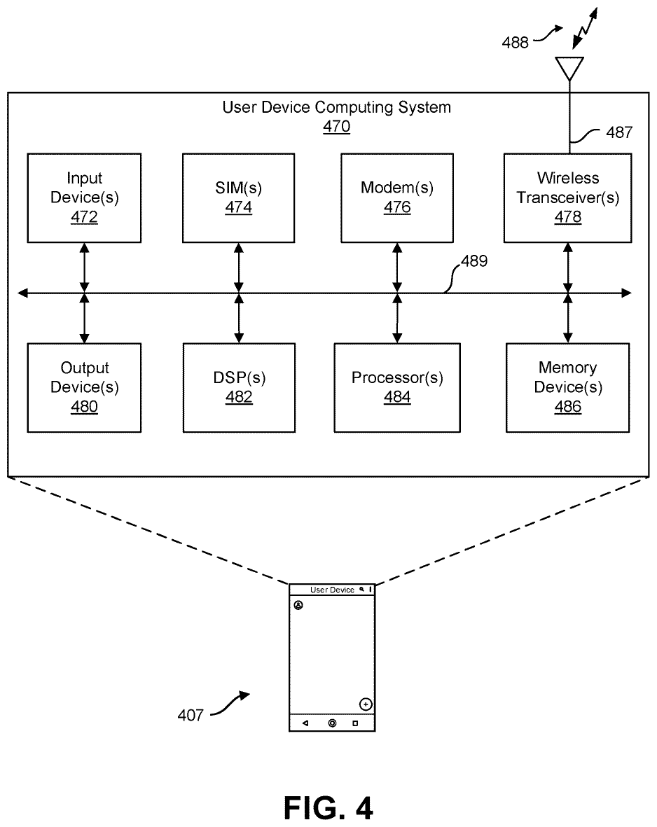

FIG. 4 illustrates an example of a computing system 470 of a wireless device 407. The wireless device 407 may include a client device such as a UE (e.g., UE 104, UE 152, UE 190) or other type of device (e.g., a station (STA) configured to communicate using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

As noted previously, systems and techniques are described herein for signaling of cell changes and/or beam changes. For instance, the systems and techniques may provide Layer 1 (L1) and/or Layer 2 (L2) signaling of cell and/or beam changes. Alternatively or in addition, in some aspects, the systems and techniques can provide a selective L1 measurement process in a more flexible way than previously available for L2 and L2 mobility.

In some networks, a unified transmission configuration indicator (TCI) may be used to indicate a common TCI state for multiple channels, multiple reference signals (RSs), or a channel and an RS. For example, a network may support different types of unified TCIs, such as Type 1 (where a joint TCI state indicates a common beam for at least one downlink channel and/or downlink RS in addition to at least one uplink channel and/or uplink RS), Type 2 (where a downlink TCI state indicates a common beam for more than one downlink channel and/or downlink RS), and/or Type 3 (where a common TCI state indicates a common beam for more than one uplink channel and/or uplink RS).

For at least 3GPP Release 18 (R18) L1/L2 based mobility, L1/L2 signaling for serving cell changes is to be specified. For example, to specify mechanisms and procedures of L1/L2 based inter-cell mobility for mobility latency reduction, the following may be addressed: configuration and maintenance for multiple candidate cells to allow fast application of configurations for candidate cells [RAN2, RAN3]; Dynamic switch mechanism among candidate serving cells (e.g., including a Special Cells (SpCells) and SCells) for potential applicable scenarios based on L1/L2 signaling [RAN2, RAN1]; L1 enhancements for inter-cell beam management, including L1 measurement and reporting, and beam indication [RAN1, RAN2] (Note 1: Early RAN2 involvement is necessary, including the possibility of further clarifying the interaction between this bullet with the previous bullet); Timing Advance management [RAN1, RAN2]; and CU-DU interface signaling to support L1/L2 mobility, if needed [RAN3].

The systems and techniques described herein can address at least the dynamic switching mechanism among candidate serving cells (e.g., including SpCells and SCells) for the potential applicable scenarios based on L1/L2 signaling and the L1 enhancements for beam indication. For example, the systems and techniques can determine a triggering condition has been met and can apply a selective L1 measurement strategy (e.g., skipping L1 measurements or reducing L1 measurement frequency) based on the triggering condition. In some cases, based on performing selective L1 measurements, the systems and techniques can result in saving battery power of a UE when transitioning the UE from a serving cell to a candidate cell.

The term SpCell refers to a Special Cell. In some cases, such as for Dual Connectivity operation, the term Special Cell (SpCell) may refer to the Primary Cell (PCell) of the Master Cell Group (MCG) or the PSCell of the Secondary Cell Group (SCG) depending on if the MAC entity is associated to the MCG or the SCG, respectively. Otherwise the term Special Cell may refer to the PCell. A Special Cell may support Physical Uplink Control Channel (PUCCH) transmission and contention-based Random Access, and in some cases is always activated.

In some cases, with respect to preconfigured candidate cells for an L1/L2 based cell changes, a set of candidate cells may be configured as serving cell(s) within a cell group at least for SpCell reselection. A first option (denoted as Option 1) and a second option (denoted as Option 2) are as follows (with differences between Options 1 and 2 shown with text between brackets—e.g., “<differences>”): Option 1: A subset of configured serving cells are dedicated as candidate cells for SpCell selection; Only one candidate cell is selected as SpCell at a given time, and <remaining candidate cells not selected as SpCell are not used for data and control communications>; and Each serving cell configured in the cell group but not in the candidate cell subset may be activated or deactivated as SCell for data and/or control communications.

The second option (Option 2) includes: Any or subset of serving cells configured in the cell group can be a candidate cell: Dedicated cell switching signaling selects a candidate cell as the new SpCell; The selected candidate cell is previously activated to be ready for data and/or control communications, e.g. as an activated SCell, or is either activated or deactivated before the selection, e.g. as a deactivated SCell; To save overhead, some serving cell config for SpCell functions may be valid only when the candidate cell is selected as SpCell, e.g. SSB, RACH (or PRACH), paging, S1 config; and <Each serving cell including candidate cell configured in the cell group if not selected as SpCell can be activated or deactivated as SCell for data and control communications>.

For both Options 1 and 2, the activated SCells not selected as the new SpCell after the selection may have the following behavior: they are implicitly deactivated after SpCell change, and may be reactivated later after potential RRC reconfiguration; or they remain activated after SpCell change.

In some examples, individual cell selection may be implemented using separate cell signaling for PCell change and/or SCell change in case of carrier aggregation. In some aspects, beam indication based PCell selection can be performed. In some cases, SCell selection can be based on legacy protocols and/or new L1/L2 signaling, as discussed further herein. In some instances, a single PCell (e.g., without carrier aggregation and/or dual connectivity) may be selected among a pre-configured candidate PCell set. In some examples, a PCell change may include sweeping the role between a PCell and a SCell among a pre-configured candidate PCell set.

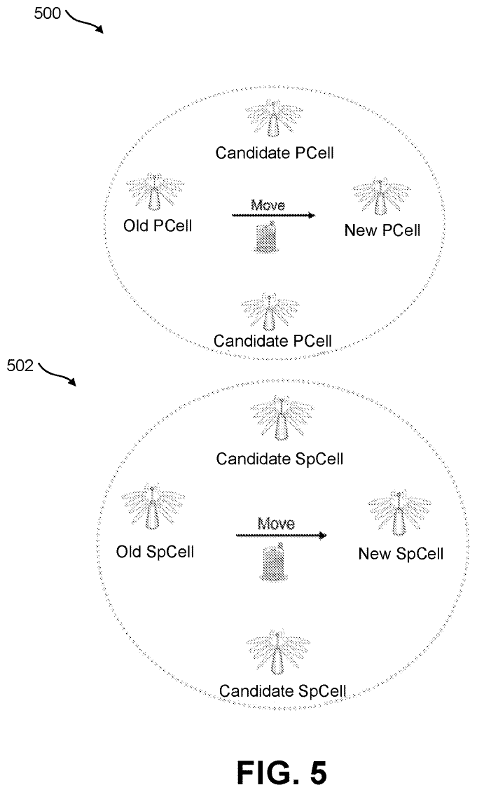

FIG. 5 illustrates an example 500 of a single PCell change without carrier aggregation. In some aspects, the UE may switch from the Old PCell to the New PCell from among a pre-configured candidate PCell set. FIG. 5 also illustrates another example 502 of a single special cell (SpCell) change without carrier aggregation. In R18 L1/L2 mobility, at least the SpCell can be updated via L1/L2 signaling based on an L1 measurement. The example 502 provides the context for the present claims related to selective L1 measurement strategies that can include one or more of a process of skipping the L1 measurement or reducing the L1 measurement frequency.

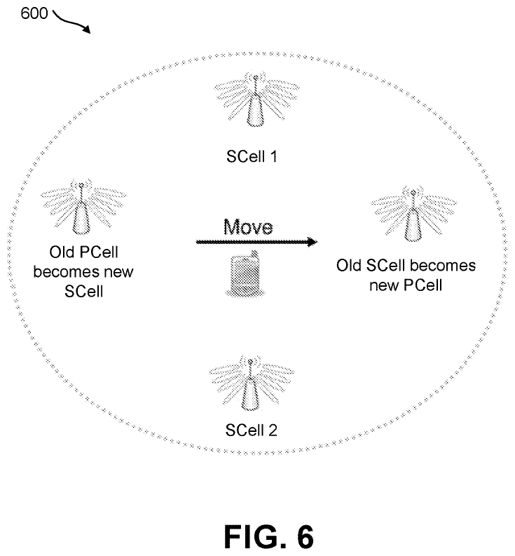

FIG. 6 illustrates an example of an individual PCell and SCell change in carrier aggregation. In some examples, the Old SCell may be changed into the new PCell. In some cases, the old PCell may be changed into the new SCell. In some examples, the new SCell may be implicitly deactivated after SpCell change, and may be reactivated later after potential RRC reconfiguration; or the new SCell may remain activated after SpCell change.

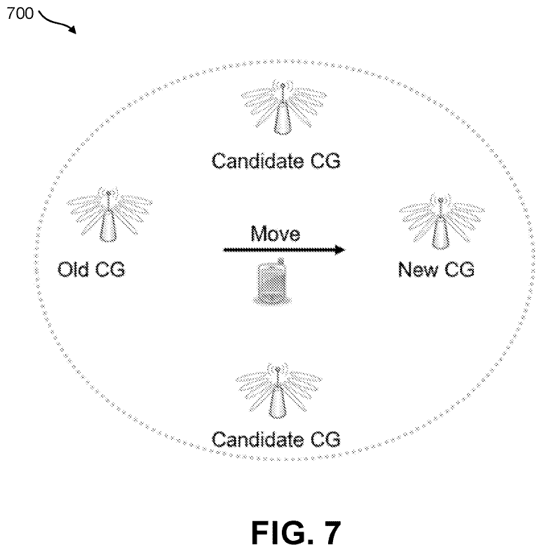

FIG. 7 illustrates an example of cell group based selection in which an SpCell and an SCell may be switched together in the case of carrier aggregation. In some aspects, cell group switch signaling may be based on an extension of signaling for example in FIG. 6. In some examples, a UE may switch from an old cell group to a new cell group, as illustrated in FIG. 7.

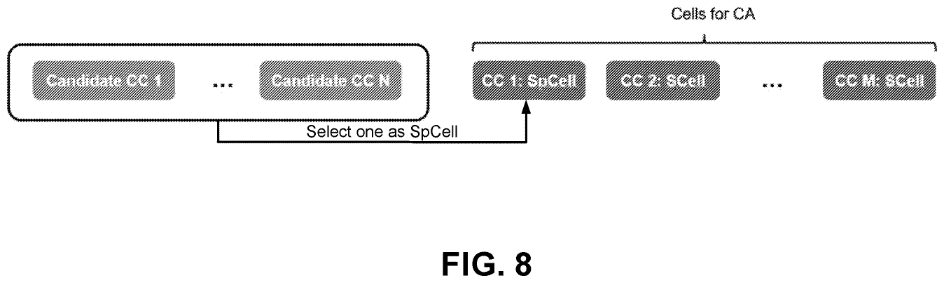

FIG. 8 illustrates an example of preconfigured candidate cells for L1/L2 based SpCell change. In some examples, FIG. 8 may correspond to Option 1 set forth above in which a subset of serving cells are dedicated as candidate cells for SpCell selection (e.g., candidate Pcells in an Information Element (IE) such as CellGroupConfig, including candidate component carrier (CC1) to candidate CC N). In some cases, only one candidate cell may be selected as SpCell at a given time and one or more remaining candidate cells that are not selected may not be used for data and control communications.

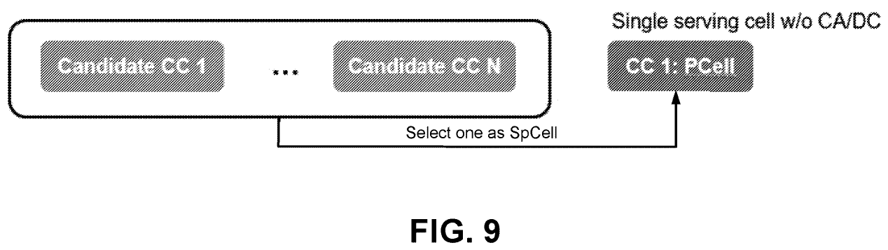

FIG. 9 illustrates another example of preconfigured candidate cells for L1/L2 based SpCell selection. As illustrated in FIG. 9, in a case of a single serving cell without carrier aggregation or dual connectivity, a single PCell may be configured.

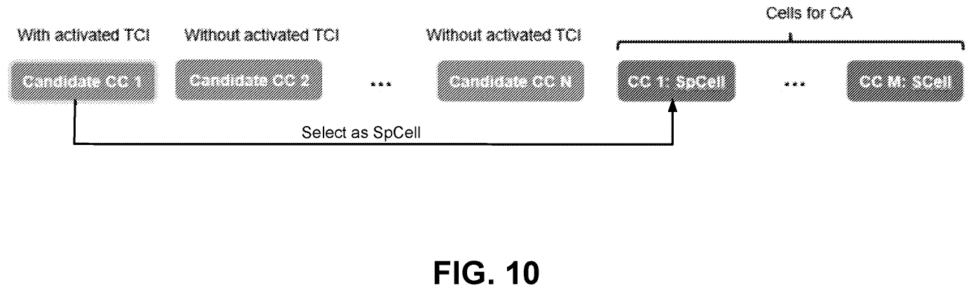

FIG. 10 illustrates an example of SpCell selection in which non-selected cells are not used for data and control communications. In some aspects, among the candidate SpCells, only the selected SpCell may have an activated transmission configuration indicator (TCI) state.

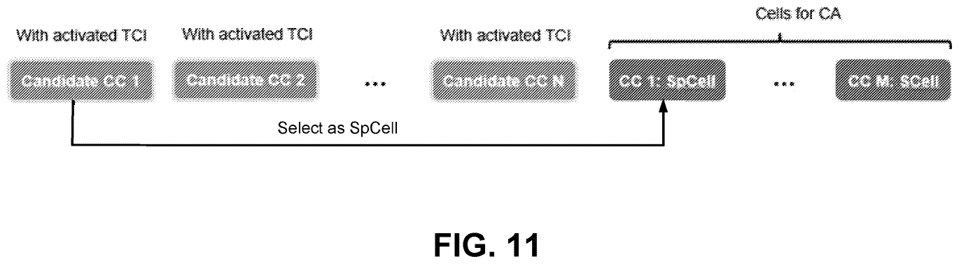

FIG. 11 illustrates another example of SpCell selection in which non-selected cells are not used for data and control communications. In some cases, among the candidate SpCells, both selected and non-selected SpCells may have activated TCI states. In some examples, the non-selected SpCells may not be used for data/control.

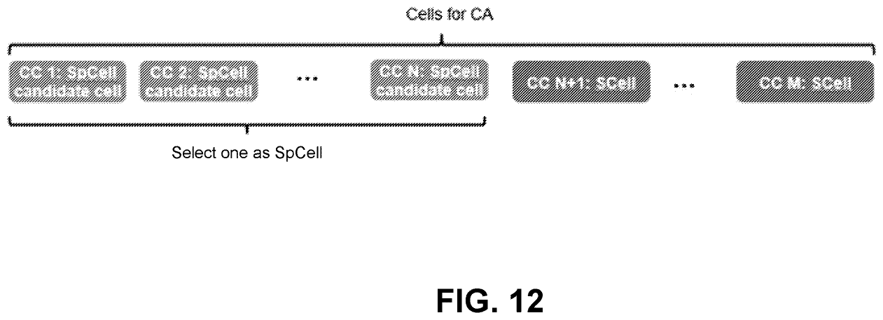

FIG. 12 illustrates an example of SpCell selection in which non-selected cells may be used for data and control communications. For example, among configured component carriers (CC) for carrier aggregation, a set of component carriers may also be candidate cells for SpCell selection (e.g., CC1 to N). In some aspects, a difference between the example illustrated in FIG. 12 and the examples illustrated in FIG. 10 or FIG. 11 is that a candidate cell not selected as SpCell may be used for data and control communications (e.g., as an activated SCell). In some instances, the example illustrated in FIG. 12 may include carrier aggregation. In some aspects relating to a single serving cell, it may be virtually achieved by only activating the SpCell while keeping all SCells deactivated.

In the R18 description for L1/L2 mobility, there are objectives for that work item. The objectives include: to specify a mechanism and procedures of L1/L2 based inter-cell mobility for mobility latency reduction in the following areas: (1) Configuration and maintenance for multiple candidate cells to allow fast application of configurations for candidate cells [RAN2, RAN3]; (2) Dynamic switch mechanism among candidate serving cells (including SpCell and SCell) for the potential applicable scenarios based on L1/L2 signaling [RAN2, RAN1]; and (3) L1 enhancements for inter-cell beam management, including L1 measurement and reporting, and beam indication [RAN1, RAN2]. Early RAN2 involvement may be necessary, including the possibility of further clarifying the interaction between item (3) and item (2). Other areas include: (4) Timing Advance management [RAN1, RAN2] and (5) CU-DU interface signaling to support L1/L2 mobility, if needed [RAN3]. FR2 specific enhancements are not precluded, if any.

Further, the procedure of L1/L2 based inter-cell mobility is applicable to the following scenarios: (1) Standalone, CA and NR-DC case with serving cell change within one CG; (2) Intra-DU case and intra-CU inter-DU case (applicable for Standalone and CA: no new RAN interfaces are expected); (3) Both intra and inter-frequency are in scope; (4) Both FR1 (frequency range 1, including Sub6 Ghz bands) and FR2 (frequency range 2, including millimeter wave (mmwave) of 6 Ghz or higher) are in scope; and (5) Source and target cells may be synchronized or non-synchronized. These objects provide the basis for the improvements disclosed herein related to selective L1 measurement techniques.

As noted previously, the systems and techniques described herein can apply a selective L1 measurement strategy (e.g., skipping L1 measurements or reducing L1 measurement frequency) based on one or more triggering conditions. In one illustrative example, the systems and techniques can perform various operations, such as a first operation of determining cells that are in a triggering evaluation (e.g., the cells that will be evaluated for a triggering condition), a second operation of determining a cell metric type that will be used for the evaluation, a third operation of determining the triggering conditions (allowing more flexible combinations as compared to current systems), and fourth operation including a UE response of performing selective L1 measurements. The first operation can allow the evaluation of a triggering condition to be performed on a primary cell and other candidate cells, whereas current systems only apply an evaluation on a primary serving cell of the UE, as described above. The second operation can allow evaluation of various metrics to be applied, whereas current systems only apply an L3 RSRP metric, as described above.

The systems and techniques can utilize various options for the first operation of determining the cells used in the triggering evaluation. For example, a first option for the first operation includes a fixed rule, where serving and/or candidate PCell, PSCell(s) are determined to be used in the triggering evaluation. A second option for the first operation includes the serving and/or candidate cell(s) to be used in the triggering evaluation are determined by the base station configurations. A third option for the first operation includes any or all of the serving or candidate cells(s) including Pcell or not Pcell are determined to be used in the triggering evaluation.

The systems and techniques can also utilize various options for the second operation of determining the cell metric type. For example, a first option for the second operation includes a metric related to a cell level, e.g., L3 cell quality such as L3 SS-RSRP, or L3 SS-SINR, or L1 cell quality such as L1-SINR, L1-RSRP. One illustrative example of the first option includes a cell-average value for the qualities of multiple RSs in one cell. A second option for the second operation includes a metric related to the top-X RSs in the cell (where X can be equal to a value of 1 or greater). A third option for the second operation includes a metric related to all or at least one predetermined RS (e.g., beam failure detection RS) in the cell. A fourth option for the second operation includes a metric related to a mTRP operation, e.g., in mTRP operation where 2 TCIs are indicated, the metric of the QCL RS of the 2 or at least 1 indicated TCI are used for the cell metric type.

The systems and techniques can also utilize various options for the third operation of determining the triggering conditions, such as a low mobility condition (e.g., one or multiple serving/candidate cells are in low mobility), a serving cell having a high-quality (or too good) condition (e.g., a high-quality serving cell and one of multiple serving/candidate cells having high quality), a serving cell having a high-quality (or too good) condition and a candidate cell having a low-quality (or too bad) condition (e.g., a serving cell having high quality and all candidate cells have low quality or a serving cell having high quality and an individual cell has low quality).

The systems and techniques can also utilize various options for the fourth operation including the UE response of performing selective L1 measurements. A first option for the fourth operation includes skipping L1 measurement(s). A second option for the fourth operation includes reducing L1 measurement frequency (e.g., increase the measurement periodicity). In one illustrative example, when one cell reaches or satisfies a triggering condition, the UE can skip measurement(s) corresponding to the cell or can reduce the measurement frequency for the cell. In another illustrative example, when one cell reaches or satisfies a triggering condition, the UE can skip measurements corresponding to all cells or can reduce the measurement frequency for the cells. In another illustrative example, when all cells reach or satisfy a triggering condition, the UE can skip measurements corresponding to all cells or can reduce the measurement frequency for the cells.

In one illustrative example of performing the techniques described herein, a UE may be in a low mobility condition, in which case there is no need for L1 measurement (e.g., for lower layer triggered mobility (LTM)). For instance, in L1/L2 based mobility when a UE is enabled with event-triggered L1 measurement for candidate cells, the UE may receive a low mobility configuration (e.g., with values of S_{SearchDeltaP-Connected} and T_{SearchDeltaP-Connected}, where S_{SearchDeltaP-Connected} specifies a threshold (e.g., in Decibels (dB)) for received signals for a relaxed measurement and T_{SearchDeltaP-Connected} specifies a time period over which the received signals are evaluated for relaxed measurement), and the UE may perform selective L1 measurement when in a low mobility condition.

In some aspects, a relaxed measurement criterion for a low mobility condition is fulfilled when the following condition is met:

(cell metric_{Ref}−cell metric)<S_{SearchDeltaP-Connected}.

The cell metric is determined in operation 2 (e.g., current L1 or L3 RSRP measurement of the cell based on SSB (dB)), the cell metric_{Ref} is determined in operation 2 (e.g., reference L1 or L3 RSRP measurement of the reference cell based on SSB (dB), set as follows: after receiving low mobility criterion configuration or if (cell metric−cell metric_{Ref})>0, or if the relaxed measurement criterion has not been met for TSearchDeltaP-Connected, then the UE may (or shall in some cases) set the value of cell metric_{Ref} to the current cell metric value of the cell.

In another illustrative example of performing the techniques described herein, a UE may be in a high-quality cell (or good cell quality) condition, in which case there is no need for L1 measurement (e.g., for LTM). For instance, in L1/L2 based mobility when a UE is enabled with event-triggered L1 measurement for candidate cells, the UE may receive a high-quality or good cell quality configuration (e.g., with values of Qin and/or X) and may perform selective L1 measurement when in a high-quality or good cell quality condition.

In some aspects, a relaxed measurement criterion for a good cell quality condition is fulfilled when the following condition is met:

$$cell metric > {Q}_{in} + X dB , or cell metrix > {Q}_{i n}$$

The cell metric is determined in operation 2 (e.g., current L1 or L3 RSRP measurement of the cell based on SSB (dB)). The threshold Qin can be configured or fixed. The term X may be configured as a parameter offset (also referred to herein as an offset parameter) in a goodCellEvaluationLTM field or information element (IE). In some cases, goodCellEvaluationLTM field can be associated with a good cell quality criterion in an radio resource control (RRC) connected (RRC_CONNECTED) message indicating that a radio resource control is in a connected state for a cell operating in a first frequency range and a second frequency range, respectively.

In another illustrative example of performing the techniques described herein, a candidate cell may be in a poor cell quality condition as compared to an active cell, in which case there is no need for L1 measurement (e.g., for LTM). For instance, in L1/L2 based mobility when a UE is enabled with L1 measurement for candidate cells, the UE may receive a low-quality or bad candidate-cell configuration (e.g., with values of S_{SearchDeltaP-Connected}) and may perform selective L1 measurement when the candidate cell is in a low-quality or bad candidate-cell scenario.

In some aspects, a relaxed measurement criterion for bad candidate-cell condition is fulfilled for the candidate cell when one or more of the following conditions is met:

$$Option 1 : ( cell {metric}_{candidate} - cell {metric}_{serving} ) < {S}_{SearchDeltaP - Connected} ,$$

$$Option 2 : cell {metric}_{candidate} < {S}_{SearchDeltaP - Connected} ,$$

The cell metric candidate is determined in operation 2 (e.g., current L1 or L3 RSRP measurement of the candidate cell based on SSB (dB)). The cell metric serving is also determined in operation 2 (e.g., current L1 or L3 RSRP measurement of the active cell based on SSB (dB)).

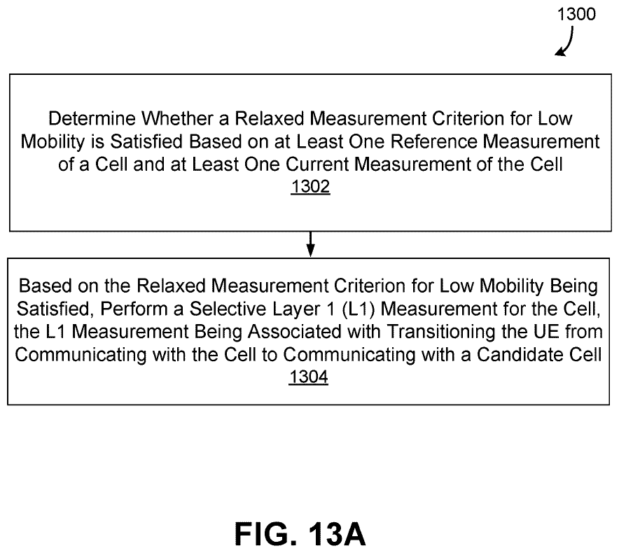

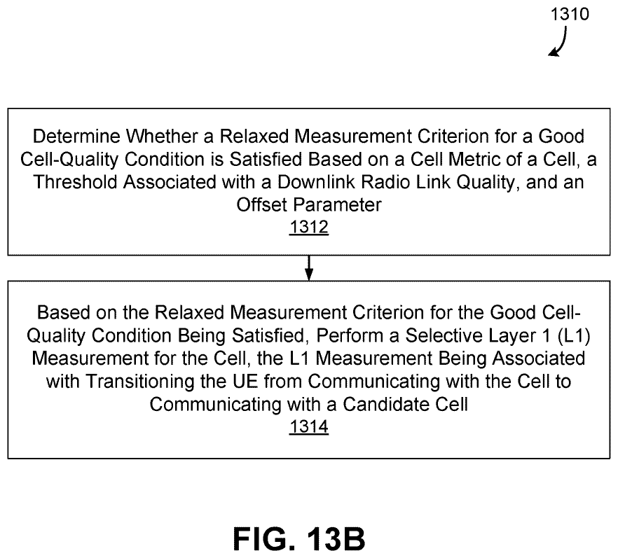

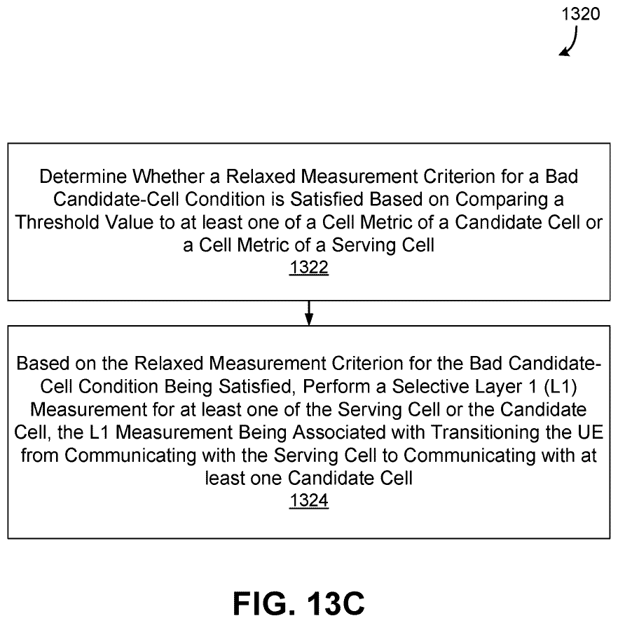

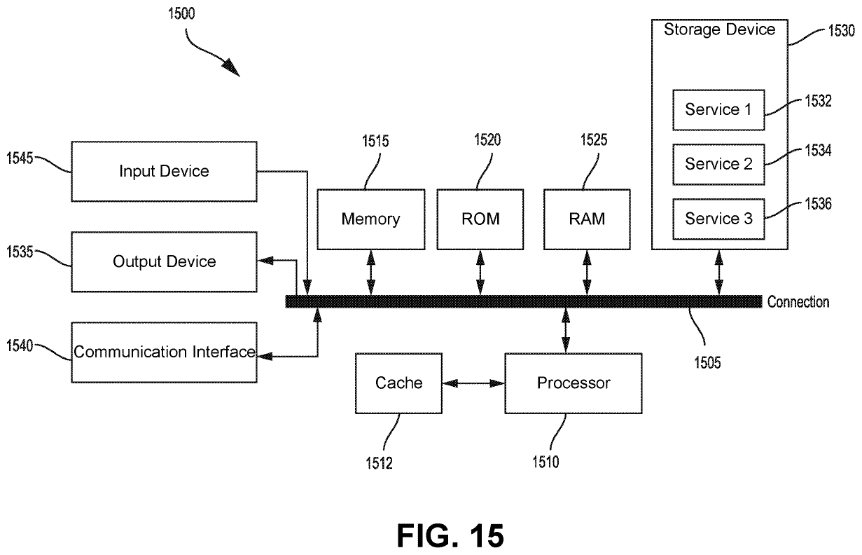

FIG. 13A is a flow diagram illustrating an example of a process 1300 for performing wireless communication, in accordance with some examples disclosed herein. The operations of the process 1300 may be implemented as software components that are executed and run on one or more processors (e.g., processor 1510 of FIG. 15 and/or other processor(s)). The process 1300 can be performed by any device or group of devices. The operations of the process 1300 may be implemented as software components that are executed and run on one or more processors (e.g., processor 1510 of FIG. 15 and/or other processor(s)).

At block 1302, the process 1300 includes determining (e.g., via a UE or via computing device 1500) whether a relaxed measurement criterion for low mobility is satisfied based on at least one reference measurement of a cell and at least one current measurement of the cell.

At block 1304, the process 1300 includes, based on the relaxed measurement criterion for low mobility being satisfied, performing (e.g., via a UE or via computing device 1500) a selective layer 1 (L1) measurement for the cell, the L1 measurement being associated with transitioning the UE from communicating with the cell to communicating with a candidate cell.

In some aspects, the techniques described herein relate to a method or process 1300, wherein the selective L1 measurement includes one of suspending L1 measurements for the cell or reducing a frequency of the L1 measurements for the cell.

In some aspects, the techniques described herein relate to a method or process, wherein determining the relaxed measurement criterion includes comparing a difference of the at least one current measurement from the at least one reference measurement to a threshold value.

In some aspects, the techniques described herein relate to a method or process 1300, wherein the at least one reference measurement includes a reference Layer 1 (L1) reference signal received power (RSRP) measurement of the cell based on a synchronization signal block (SSB), and wherein the at least one current measurement includes a current L1 RSRP measurement of the cell based on an SSB.

In some aspects, the techniques described herein relate to a method or process 1300, wherein the at least one reference measurement includes a reference Layer 3 (L3) reference signal received power (RSRP) measurement of the cell based on a first synchronization signal block (SSB), and wherein the at least one current measurement includes a current L3 RSRP measurement of the cell based on a second SSB.

In some aspects, the techniques described herein relate to a method or process 1300, the method or process further including determining the at least one reference measurement based on at least one of receiving a low mobility criterion configuration, a difference of the at least one reference measurement from the at least one current measurement being greater than 0, or the relaxed measurement criterion not being met for a period of time.

In some aspects, the techniques described herein relate to a method or process 1300, wherein a current measurement for the cell is set as a reference measurement for the cell for the relaxed measurement criterion based on at least one of determining the relaxed measurement criterion, a difference of the reference measurement from the current measurement being greater than 0, or the relaxed measurement criterion not being met for a period of time.

In some aspects, the techniques described herein relate to a method or process 1300, wherein the cell includes one of a source cell, an active cell, a serving cell, a target cell, a non-serving cell, or the candidate cell.

In some aspects, the techniques described herein relate to a method or process 1300, wherein the UE is configured to receive layer 1 measurement data for candidate cells.

In some aspects, the techniques described herein relate to an apparatus for wireless communications, including: at least one memory; and at least one processor coupled to at least one memory and configured to: determine whether a relaxed measurement criterion for low mobility is satisfied based on at least one reference measurement of a cell and at least one current measurement of the cell; and based on the relaxed measurement criterion for low mobility being satisfied, perform a selective layer 1 (L1) measurement for the cell, the L1 measurement being associated with transitioning the apparatus from communicating with the cell to communicating with a candidate cell.

In some aspects, the techniques described herein relate to an apparatus, wherein the selective L1 measurement includes one of suspending L1 measurements for the cell or reducing a frequency of the L1 measurements for the cell.

In some aspects, the techniques described herein relate to an apparatus, wherein, to determine the relaxed measurement criterion, the at least one processor is configured to compare a difference of the at least one current measurement from the at least one reference measurement to a threshold value.

In some aspects, the techniques described herein relate to an apparatus, wherein the at least one reference measurement includes a reference Layer 1 (L1) reference signal received power (RSRP) measurement of the cell based on a synchronization signal block (SSB), and wherein the at least one current measurement includes a current L1 RSRP measurement of the cell based on an SSB.

In some aspects, the techniques described herein relate to an apparatus, wherein the at least one reference measurement includes a reference Layer 3 (L3) reference signal received power (RSRP) measurement of the cell based on a first synchronization signal block (SSB), and wherein the at least one current measurement includes a current L3 RSRP measurement of the cell based on a second SSB.

In some aspects, the techniques described herein relate to an apparatus, wherein the at least one processor is configured to determine the at least one reference measurement based on at least one of receiving a low mobility criterion configuration, a difference of the at least one reference measurement from the at least one current measurement being greater than 0, or the relaxed measurement criterion not being met for a period of time.

In some aspects, the techniques described herein relate to an apparatus, wherein the at least one processor is configured to set a current measurement for the cell as a reference measurement for the cell for the relaxed measurement criterion based on at least one of determining the relaxed measurement criterion, a difference of the reference measurement from the current measurement being greater than 0, or the relaxed measurement criterion not being met for a period of time.

In some aspects, the techniques described herein relate to an apparatus, wherein the cell includes one of a source cell, an active cell, a serving cell, a target cell, a non-serving cell, or the candidate cell.

In some aspects, the techniques described herein relate to an apparatus, wherein the apparatus is configured to receive layer 1 measurement data for candidate cells.

In some aspects, the techniques described herein relate to a non-transitory computer-readable medium having stored thereon instructions that, when executed by one or more processors, cause the one or more processors to be configured to: determine whether a relaxed measurement criterion for low mobility is satisfied based on at least one reference measurement of a cell and at least one current measurement of the cell; and based on the relaxed measurement criterion for low mobility being satisfied, perform a selective layer 1 (L1) measurement for the cell, the L1 measurement being associated with transitioning the apparatus from communicating with the cell to communicating with a candidate cell

In some aspects, the techniques described herein relate to an apparatus for wireless communications, the apparatus including one or more means for determining whether a relaxed measurement criterion for low mobility is satisfied based on at least one reference measurement of a cell and at least one current measurement of the cell; and means for, based on the relaxed measurement criterion for low mobility being satisfied, performing a selective layer 1 (L1) measurement for the cell, the L1 measurement being associated with transitioning the UE from communicating with the cell to communicating with a candidate cell.

FIG. 13B is a flow diagram illustrating an example of a process 1310 for performing wireless communication, in accordance with some examples disclosed herein. The operations of the process 1310 may be implemented as software components that are executed and run on one or more processors (e.g., processor 1510 of FIG. 15 and/or other processor(s)). The process 1310 can be performed by any device or group of devices. The operations of the process 1310 may be implemented as software components that are executed and run on one or more processors (e.g., processor 1510 of FIG. 15 and/or other processor(s)).

At block 1312, the process 1310 includes determining (e.g., via a UE or via computing device 1500) whether a relaxed measurement criterion for a good cell-quality condition is satisfied based on a cell metric of a cell, a threshold associated with a downlink radio link quality, and an offset parameter. Any one or more of these conditions can be met in the determining step.

At block 1314, the process 1310 includes, based on the relaxed measurement criterion for the good cell-quality condition being satisfied, performing a selective layer 1 (L1) measurement for the cell, the L1 measurement being associated with transitioning the UE from communicating with the cell to communicating with a candidate cell.

In some aspects, the techniques described herein relate to a method or process 1310, wherein the selective L1 measurement includes one of suspending L1 measurements for the cell or reducing a frequency of the L1 measurements for the cell.

In some aspects, the techniques described herein relate to a method or process 1310, wherein determining the relaxed measurement criterion for the good cell-quality condition is satisfied includes: determining the cell metric of the cell is greater than a sum of the threshold associated with the downlink radio link quality and the offset parameter.

In some aspects, the techniques described herein relate to a method or process 1310, wherein the threshold is configured by a network entity.

In some aspects, the techniques described herein relate to a method or process 1310, wherein the threshold is fixed.

In some aspects, the techniques described herein relate to a method or process 1310, wherein the cell metric includes a reference Layer 1 (L1) reference signal received power (RSRP) measurement of the cell based on a synchronization signal block (SSB).

In some aspects, the techniques described herein relate to a method or process 1310, wherein the cell metric includes a reference Layer 3 (L3) reference signal received power (RSRP) measurement of the cell based on a synchronization signal block (SSB).

In some aspects, the techniques described herein relate to a method or process 1310, wherein the UE is configured for receiving layer 1 measurement data for candidate cells.

In some aspects, the techniques described herein relate to an apparatus for wireless communications, including: at least one memory; and at least one processor coupled to at least one memory and configured to: determine whether a relaxed measurement criterion for a good cell-quality condition is satisfied based on a cell metric of a cell, a threshold associated with a downlink radio link quality, and an offset parameter; and based on the relaxed measurement criterion for the good cell-quality condition being satisfied, perform a selective layer 1 (L1) measurement for the cell, the L1 measurement being associated with transitioning the apparatus from communicating with the cell to communicating with a candidate cell.

In some aspects, the techniques described herein relate to an apparatus, wherein the selective L1 measurement includes one of suspending L1 measurements for the cell or reducing a frequency of the L1 measurements for the cell.

In some aspects, the techniques described herein relate to an apparatus, wherein, to determine the relaxed measurement criterion for the good cell-quality condition is satisfied, the at least one processor is configured to: determine the cell metric of the cell is greater than a sum of the threshold associated with the downlink radio link quality and the offset parameter.

In some aspects, the techniques described herein relate to an apparatus, wherein the threshold is configured by a network entity.

In some aspects, the techniques described herein relate to an apparatus, wherein the threshold is fixed.

In some aspects, the techniques described herein relate to an apparatus, wherein the cell metric includes a reference Layer 1 (L1) reference signal received power (RSRP) measurement of the cell based on a synchronization signal block (SSB).

In some aspects, the techniques described herein relate to an apparatus, wherein the cell metric includes a reference Layer 3 (L3) reference signal received power (RSRP) measurement of the cell based on a synchronization signal block (SSB).

In some aspects, the techniques described herein relate to an apparatus, wherein the apparatus is configured for receiving layer 1 measurement data for candidate cells.

In some aspects, the techniques described herein relate to a non-transitory computer-readable medium having stored thereon instructions that, when executed by one or more processors, cause the one or more processors to be configured to: determine whether a relaxed measurement criterion for a good cell-quality condition is satisfied based on a cell metric of a cell, a threshold associated with a downlink radio link quality, and an offset parameter; and based on the relaxed measurement criterion for the good cell-quality condition being satisfied, perform a selective layer 1 (L1) measurement for the cell, the L1 measurement being associated with transitioning the apparatus from communicating with the cell to communicating with a candidate cell.

In some aspects, the techniques described herein relate to an apparatus for wireless communications, the apparatus including one or more means for determining whether a relaxed measurement criterion for a good cell-quality condition is satisfied based on a cell metric of a cell, a threshold associated with a downlink radio link quality, and an offset parameter; and means for, based on the relaxed measurement criterion for the good cell-quality condition being satisfied, performing a selective layer 1 (L1) measurement for the cell, the L1 measurement being associated with transitioning the UE from communicating with the cell to communicating with a candidate cell.

FIG. 13C is a flow diagram illustrating an example of a process 1320 for performing wireless communication, in accordance with some examples disclosed herein. The operations of the process 1320 may be implemented as software components that are executed and run on one or more processors (e.g., processor 1510 of FIG. 15 and/or other processor(s)). The process 1320 can be performed by any device or group of devices. The operations of the process 1320 may be implemented as software components that are executed and run on one or more processors (e.g., processor 1510 of FIG. 15 and/or other processor(s)).

At block 1322, the process 1320 includes determining (e.g., via a UE or via computing device 1500) whether a relaxed measurement criterion for a bad candidate-cell condition is satisfied based on comparing a threshold value to at least one of a cell metric of a candidate cell or a cell metric of a serving cell.

At block 1324, the process 1320 includes, based on the relaxed measurement criterion for the bad candidate-cell condition being satisfied, performing a selective layer 1 (L1) measurement for at least one of the serving cell or the candidate cell, the L1 measurement being associated with transitioning the UE from communicating with the serving cell to communicating with at least one candidate cell.

In some aspects, the techniques described herein relate to a method or process 1320, wherein the selective L1 measurement includes one of suspending L1 measurements for at least one of the serving cell or the candidate cell or reducing a frequency of the L1 measurements for at least one of the serving cell or the candidate cell.

In some aspects, the techniques described herein relate to a method or process 1320, wherein determining the relaxed measurement criterion for the bad candidate-cell condition is satisfied includes: determining a difference of the cell metric of the serving cell from the cell metric of the serving cell is less than the threshold value.

In some aspects, the techniques described herein relate to a method or process 1320, wherein determining the relaxed measurement criterion for the bad candidate-cell condition is satisfied includes: determining the cell metric of the candidate cell is less than the threshold value.

In some aspects, the techniques described herein relate to a method or process 1320, wherein the cell metric of the candidate cell includes a current Layer 1 (L1) reference signal received power (RSRP) measurement of the candidate cell based on a first synchronization signal block (SSB) and wherein the cell metric of the serving cell includes a current layer 1 RSRP measurement of the serving cell based on a second SSB.

In some aspects, the techniques described herein relate to a method or process 1320, wherein the cell metric of the candidate cell includes a current Layer 3 (L3) reference signal received power (RSRP) measurement of the candidate cell based on a first synchronization signal block (SSB) and wherein the cell metric of the serving cell includes a current layer 3 RSRP measurement of the serving cell based on a second SSB.

In some aspects, the techniques described herein relate to an apparatus for wireless communication, including: at least one memory; and at least one processor coupled to at least one memory and configured to: determine whether a relaxed measurement criterion for a bad candidate-cell condition is satisfied based on comparing a threshold value to at least one of a cell metric of a candidate cell or a cell metric of a serving cell; and based on the relaxed measurement criterion for the bad candidate-cell condition being satisfied, perform a selective layer 1 (L1) measurement for at least one of the serving cell or the candidate cell, the L1 measurement being associated with transitioning the apparatus from communicating with the serving cell to communicating with at least one candidate cell.

In some aspects, the techniques described herein relate to an apparatus, wherein the selective L1 measurement includes one of suspending L1 measurements for at least one of the serving cell or the candidate cell or reducing a frequency of the L1 measurements for at least one of the serving cell or the candidate cell.

In some aspects, the techniques described herein relate to an apparatus, wherein, to determine the relaxed measurement criterion for the bad candidate-cell condition is satisfied, the at least one processor is configured to: determine a difference of the cell metric of the serving cell from the cell metric of the serving cell is less than the threshold value.

In some aspects, the techniques described herein relate to an apparatus, wherein, to determine the relaxed measurement criterion for the bad candidate-cell condition is satisfied, the at least one processor is configured to: determine the cell metric of the candidate cell is less than the threshold value.

In some aspects, the techniques described herein relate to an apparatus, wherein the cell metric of the candidate cell includes a current Layer 1 (L1) reference signal received power (RSRP) measurement of the candidate cell based on a first synchronization signal block (SSB) and wherein the cell metric of the serving cell includes a current layer 1 RSRP measurement of the serving serving cell based on a second SSB.

In some aspects, the techniques described herein relate to an apparatus, wherein the cell metric of the candidate cell includes a current Layer 3 (L3) reference signal received power (RSRP) measurement of the candidate cell based on a first synchronization signal block (SSB) and wherein the cell metric of the serving cell includes a current layer 3 RSRP measurement of the serving cell based on a second SSB.

In some aspects, the techniques described herein relate to a non-transitory computer-readable medium having stored thereon instructions that, when executed by one or more processors, cause the one or more processors to be configured to: determine whether a relaxed measurement criterion for a bad candidate-cell condition is satisfied based on comparing a threshold value to at least one of a cell metric of a candidate cell or a cell metric of a serving cell; and based on the relaxed measurement criterion for the bad candidate-cell condition being satisfied, perform a selective layer 1 (L1) measurement for at least one of the serving cell or the candidate cell, the L1 measurement being associated with transitioning the apparatus from communicating with the serving cell to communicating with at least one candidate cell.

In some aspects, the techniques described herein relate to an apparatus for wireless communications, the apparatus including one or more means for determining whether a relaxed measurement criterion for a bad candidate-cell condition is satisfied based on comparing a threshold value to at least one of a cell metric of a candidate cell or a cell metric of a serving cell; and means for, based on the relaxed measurement criterion for the bad candidate-cell condition being satisfied, performing a selective layer 1 (L1) measurement for at least one of the serving cell or the candidate cell, the L1 measurement being associated with transitioning the UE from communicating with the serving cell to communicating with at least one candidate cell.

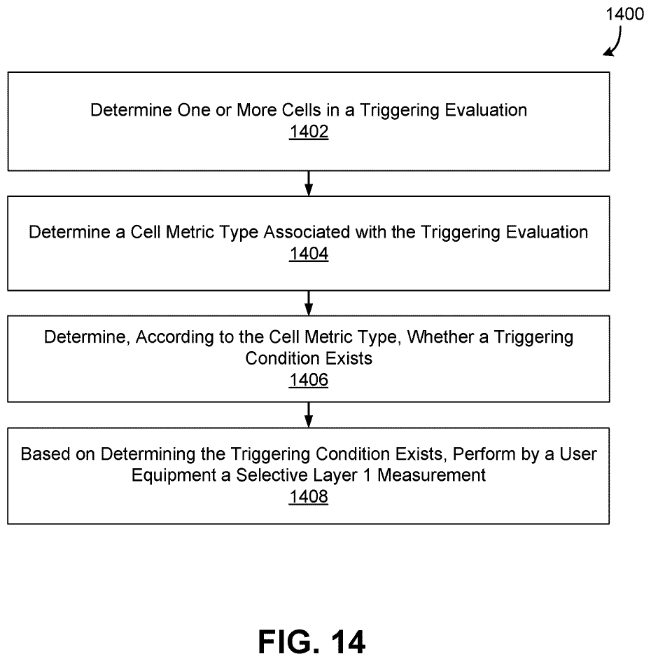

FIG. 14 is a flow diagram illustrating an example of a process 1400 for performing wireless communication, in accordance with some examples disclosed herein. The operations of the process 1400 may be implemented as software components that are executed and run on one or more processors (e.g., processor 1510 of FIG. 15 and/or other processor(s)). The process 1400 can be performed by any device or group of devices. The operations of the process 1400 may be implemented as software components that are executed and run on one or more processors (e.g., processor 1510 of FIG. 15 and/or other processor(s))

At block 1402, the process 1400 includes determining (e.g., via a UE or via computing device 1500) determining one or more cells in a triggering evaluation.

In block 1404, the process 1400 includes determining a cell metric type associated with the triggering evaluation.

In block 1406, the process 1400 includes determining, according to the cell metric type, whether a triggering condition exists.

In block 1408, the process 1400 includes, based on determining the triggering condition exists, performing a selective layer 1 (L1) measurement.

In some aspects, the techniques described herein relate to a method or process 1400, wherein the selective L1 measurement includes one of suspending L1 measurements based on a relaxed measurement criterion for low mobility being fulfilled or reducing a frequency of L1 measurement based on the relaxed measurement criterion being fulfilled.

In some aspects, the techniques described herein relate to a method or process 1400, wherein determining one or more cells in the triggering evaluation further includes determining a plurality of cells for use in the triggering evaluation.

In some aspects, the techniques described herein relate to a method or process 1400, wherein determining one or more cells in the triggering evaluation is based on a fixed rule for serving cells or candidate cells.

In some aspects, the techniques described herein relate to a method or process 1400, wherein determining one or more cells in the triggering evaluation is based on a network entity configuring serving cells or candidate cells.

In some aspects, the techniques described herein relate to a method or process 1400, wherein determining one or more cells in the triggering evaluation is based on any or all of serving cells or candidate cells, including a primary serving cell (PCell) or not including the PCell.

In some aspects, the techniques described herein relate to a method or process 1400, wherein the cell metric type includes one or more of: (1) a metric related to a cell level; (2) a layer 3 (L3) cell quality; (3) a L3 SS-RSRP (synchronization signal—reference signal received power); (4) a L3 SS-SINR (synchronization signal—signal interference noise ratio); (5) an L1 cell quality; (6) a L1-SINR; (7) a L1-RSRP; (8) an cell-average value; (9) a top X beams/reference signal (RS) in the cell; (10) all or at least one RS; (11) a beam failure detection RS in the cell; (12) a multiple transmit/receive point (mTRP); (13) a mTRP in which two transmission configuration indicators (TCIs) are indicated including a quasi-colocation (QLC) RS of the two TCIs or at least one indicated TCI.

In some aspects, the techniques described herein relate to a method or process 1400, wherein the triggering condition includes one or more of a low mobility condition, a serving cell too good condition, a serving cell too good plus a candidate cell to bad condition.

In some aspects, the techniques described herein relate to a method or process 1400, wherein the low mobility condition includes a scenario where one or multiple serving/candidate cells are in low mobility and the serving cell too good condition includes a scenario where the serving cell is too good plus one or multiple serving/candidate cells are too good.

In some aspects, the techniques described herein relate to a method or process 1400, wherein the serving cell too good plus the candidate cell to bad condition includes one of a scenario where the serving cell is too good plus all candidate cells are too bad or a scenario where the serving cell is too good plus an individual cell is too bad.

In some aspects, the techniques described herein relate to a method or process 1400, wherein the selective L1 measurement includes one or more of: (1) skipping a L1 measurement; (2) reducing a L1 measurement frequency; (3) skipping the L1 measurement or reducing the L1 measurement frequency for a single cell that reaches the triggering condition; (4) skipping the L1 measurement or reducing the L1 measurement frequency for all cells when a single cell reaches the triggering condition; (5) skipping the L1 measurement or reducing the L1 measurement frequency for all cells when all cells reach the triggering condition.

In some aspects, the techniques described herein relate to an apparatus for performing wireless communication, including: at least one memory; and at least one processor coupled to at least one memory and configured to: determine one or more cells in a triggering evaluation; determine a cell metric type associated with the triggering evaluation; determine, according to the cell metric type, whether a triggering condition exists; and based on determining the triggering condition exists, perform a selective layer 1 (L1) measurement.

In some aspects, the techniques described herein relate to an apparatus, wherein the selective L1 measurement includes one of suspending L1 measurements based on a relaxed measurement criterion for low mobility being fulfilled or reducing a frequency of L1 measurement based on the relaxed measurement criterion being fulfilled.

In some aspects, the techniques described herein relate to an apparatus, wherein determining one or more cells in the triggering evaluation further includes determining a plurality of cells for use in the triggering evaluation.

In some aspects, the techniques described herein relate to an apparatus, wherein determining one or more cells in the triggering evaluation is based on a fixed rule for serving cells or candidate cells.

In some aspects, the techniques described herein relate to an apparatus, wherein determining one or more cells in the triggering evaluation is based on a network entity configuring serving cells or candidate cells.

In some aspects, the techniques described herein relate to an apparatus, wherein determining one or more cells in the triggering evaluation is based on any or all of serving cells or candidate cells, including a primary serving cell (PCell) or not including the PCell.

In some aspects, the techniques described herein relate to an apparatus, wherein the cell metric type includes one or more of: (1) a metric related to a cell level; (2) a layer 3 (L3) cell quality; (3) a L3 SS-RSRP (synchronization signal—reference signal received power); (4) a L3 SS-SINR (synchronization signal—signal interference noise ratio); (5) an L1 cell quality; (6) a L1-SINR; (7) a L1-RSRP; (8) an cell-average value; (9) a top X beams/reference signal (RS) in the cell; (10) all or at least one RS; (11) a beam failure detection RS in the cell; (12) a multiple transmit/receive point (mTRP); (13) a mTRP in which two transmission configuration indicators (TCIs) are indicated including a quasi-colocation (QLC) RS of the two TCIs or at least one indicated TCI.

In some aspects, the techniques described herein relate to an apparatus, wherein the triggering condition includes one or more of a low mobility condition, a serving cell too good condition, a serving cell too good plus a candidate cell to bad condition.

In some aspects, the techniques described herein relate to an apparatus, wherein the low mobility condition includes a scenario where one or multiple serving/candidate cells are in low mobility and the serving cell too good condition includes a scenario where the serving cell is too good plus one or multiple serving/candidate cells are too good.

In some aspects, the techniques described herein relate to an apparatus, wherein the serving cell too good plus the candidate cell to bad condition includes one of a scenario where the serving cell is too good plus all candidate cells are too bad or a scenario where the serving cell is too good plus an individual cell is too bad.

In some aspects, the techniques described herein relate to an apparatus, wherein the selective L1 measurement includes one or more of: (1) skipping a L1 measurement; (2) reducing a L1 measurement frequency; (3) skipping the L1 measurement or reducing the L1 measurement frequency for a single cell that reaches the triggering condition; (4) skipping the L1 measurement or reducing the L1 measurement frequency for all cells when a single cell reaches the triggering condition; (5) skipping the L1 measurement or reducing the L1 measurement frequency for all cells when all cells reach the triggering condition.

In some aspects, the techniques described herein relate to a non-transitory computer-readable medium having stored thereon instructions that, when executed by one or more processors, cause the one or more processors to be configured to: determine one or more cells in a triggering evaluation; determine a cell metric type associated with the triggering evaluation; determine, according to the cell metric type, whether a triggering condition exists; and based on determining the triggering condition exists, perform a selective layer 1 (L1) measurement.

In some aspects, the techniques described herein relate to an apparatus for wireless communications, the apparatus including one or more means for determining one or more cells in a triggering evaluation; means for determining a cell metric type associated with the triggering evaluation; means for determining, according to the cell metric type, whether a triggering condition exists; and means for, based on determining the triggering condition exists, performing a selective layer 1 (L1) measurement.

In some examples, the processes described herein may be performed by a computing device or apparatus (e.g., a UE, a network entity, etc.). In one example, the processes described herein may be performed by a wireless communication device, such as a UE (e.g., the UE 407 of FIG. 4, a mobile device, and/or other UE or device). In another example, the processes described herein may be performed by a computing device with the computing system 1500 shown in FIG. 15. For instance, a wireless communication device (e.g., the UE 407 of FIG. 4 and/or other UE or device) with the computing architecture shown in FIG. 15 may include the components of the UE and may implement the operations of the processes described herein.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The processes described herein may be described or illustrated as logical flow diagrams, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 is a diagram illustrating an example of a system for implementing certain aspects of the present technology. In particular, FIG. 15 illustrates an example of computing system 1500, which may be for example any computing device making up internal computing system, a remote computing system, a camera, or any component thereof in which the components of the system are in communication with each other using connection 1505. Connection 1505 may be a physical connection using a bus, or a direct connection into processor 1510, such as in a chipset architecture. Connection 1505 may also be a virtual connection, networked connection, or logical connection.

In some aspects, computing system 1500 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1500 includes at least one processing unit (CPU or processor) 1510 and connection 1505 that communicatively couples various system components including system memory 1515, such as read-only memory (ROM) 1520 and random access memory (RAM) 1525 to processor 1510. Computing system 1500 may include a cache 1512 of high-speed memory connected directly with, in close proximity to, or integrated as part of processor 1510.

Processor 1510 may include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which may represent any number of input mechanisms, such as a microphone for speech, a touch-sensitive screen for gesture or graphical input, keyboard, mouse, motion input, speech, etc. Computing system 1500 may also include output device 1535, which may be one or more of a number of output mechanisms. In some instances, multimodal systems may enable a user to provide multiple types of input/output to communicate with computing system 1500.

Computing system 1500 may include communications interface 1540, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1530 may include software services, servers, services, etc., that when the code that defines such software is executed by the processor 1510, it causes the system to perform a function. In some aspects, a hardware service that performs a particular function may include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“>”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative Aspects of the disclosure include: Aspect 1. A method of wireless communications performed by a user equipment (UE), the method comprising: determining whether a relaxed measurement criterion for low mobility is satisfied based on at least one reference measurement of a cell and at least one current measurement of the cell; and based on the relaxed measurement criterion for low mobility being satisfied, performing a selective layer 1 (1.1) measurement for the cell, the L1 measurement being associated with transitioning the UE from communicating with the cell to communicating with a candidate cell.

Aspect 2. The method of Aspect 1, wherein the selective L1 measurement comprises one of suspending L1 measurements for the cell or reducing a frequency of the L1 measurements for the cell.

Aspect 3. The method of any one of Aspect 1 or 2, wherein determining the relaxed measurement criterion comprises comparing a difference of the at least one current measurement from the at least one reference measurement to a threshold value.

Aspect 4. The method of any one of Aspect 1 to 3, wherein the at least one reference measurement comprises a reference Layer 1 (L1) reference signal received power (RSRP) measurement of the cell based on a synchronization signal block (SSB), and wherein the at least one current measurement comprises a current L1 RSRP measurement of the cell based on an SSB.

Aspect 5. The method of any one of Aspects 1 to 3, wherein the at least one reference measurement comprises a reference Layer 3 (L3) reference signal received power (RSRP) measurement of the cell based on a first synchronization signal block (SSB), and wherein the at least one current measurement comprises a current L3 RSRP measurement of the cell based on a second SSB.

Aspect 6. The method of any of Aspects 3 to 5, further comprising determining the at least one reference measurement based on at least one of receiving a low mobility criterion configuration, a difference of the at least one reference measurement from the at least one current measurement being greater than 0, or the relaxed measurement criterion not being met for a period of time.

Aspect 7. The method of any one of Aspects 1 to 6, wherein a current measurement for the cell is set as a reference measurement for the cell for the relaxed measurement criterion based on at least one of determining the relaxed measurement criterion, a difference of the reference measurement from the current measurement being greater than 0, or the relaxed measurement criterion not being met for a period of time.

Aspect 8. The method of any one of Aspects 1 to 7, wherein the cell comprises one of a source cell, an active cell, a serving cell, a target cell, a non-serving cell, or the candidate cell.

Aspect 9. The method of any one of Aspects 1 to 8, wherein the UE is configured to receive layer 1 measurement data for candidate cells.

Aspect 10. An apparatus for wireless communications, comprising: at least one memory; and at least one processor coupled to at least one memory and configured to: determine whether a relaxed measurement criterion for low mobility is satisfied based on at least one reference measurement of a cell and at least one current measurement of the cell; and based on the relaxed measurement criterion for low mobility being satisfied, perform a selective layer 1 (L1) measurement for the cell, the L1 measurement being associated with transitioning the apparatus from communicating with the cell to communicating with a candidate cell.

Aspect 11. The apparatus of Aspect 10, wherein the selective L1 measurement comprises one of suspending L1 measurements for the cell or reducing a frequency of the L1 measurements for the cell.

Aspect 12. The apparatus of any one of Aspects 10 or 11, wherein, to determine the relaxed measurement criterion, the at least one processor is configured to compare a difference of the at least one current measurement from the at least one reference measurement to a threshold value.

Aspect 13. The apparatus of any one of Aspects 10 to 12, wherein the at least one reference measurement comprises a reference Layer 1 (L1) reference signal received power (RSRP) measurement of the cell based on a synchronization signal block (SSB), and wherein the at least one current measurement comprises a current L1 RSRP measurement of the cell based on an SSB.

Aspect 14. The apparatus of any one of Aspects 10 to 12, wherein the at least one reference measurement comprises a reference Layer 3 (L3) reference signal received power (RSRP) measurement of the cell based on a first synchronization signal block (SSB), and wherein the at least one current measurement comprises a current L3 RSRP measurement of the cell based on a second SSB.

Aspect 15. The apparatus of any one of Aspects 12 to 14, wherein the at least one processor is configured to determine the at least one reference measurement based on at least one of receiving a low mobility criterion configuration, a difference of the at least one reference measurement from the at least one current measurement being greater than 0, or the relaxed measurement criterion not being met for a period of time.

Aspect 16. The apparatus of any one of Aspects 10 to 15, wherein the at least one processor is configured to set a current measurement for the cell as a reference measurement for the cell for the relaxed measurement criterion based on at least one of determining the relaxed measurement criterion, a difference of the reference measurement from the current measurement being greater than 0, or the relaxed measurement criterion not being met for a period of time.

Aspect 17. The apparatus of any one of Aspects 10 to 16, wherein the cell comprises one of a source cell, an active cell, a serving cell, a target cell, a non-serving cell, or the candidate cell.

Aspect 18. The apparatus of any one of Aspects 10 to 17, wherein the apparatus is configured to receive layer 1 measurement data for candidate cells.

Aspect 19. A non-transitory computer-readable medium having stored thereon instructions that, when executed by one or more processors, cause the one or more processors to perform operations according to any one of Aspects 1 to 9.

Aspect 20. An apparatus for wireless communications, comprising one or more means for performing operations according to any one of Aspects 1 to 9.

Aspect 21. A method of wireless communications performed by a user equipment (UE), the method comprising: determining whether a relaxed measurement criterion for a good cell-quality condition is satisfied based on a cell metric of a cell, a threshold associated with a downlink radio link quality, and an offset parameter; and based on the relaxed measurement criterion for the good cell-quality condition being satisfied, performing a selective layer 1 (L1) measurement for the cell, the L1 measurement being associated with transitioning the UE from communicating with the cell to communicating with a candidate cell.

Aspect 22. The method of Aspect 21, wherein the selective L1 measurement comprises one of suspending L1 measurements for the cell or reducing a frequency of the L1 measurements for the cell.

Aspect 23. The method of any one of Aspects 21 or 22, wherein determining the relaxed measurement criterion for the good cell-quality condition is satisfied comprises: determining the cell metric of the cell is greater than a sum of the threshold associated with the downlink radio link quality and the offset parameter.

Aspect 24. The method of any one of Aspects 21 to 23, wherein the threshold is configured by a network entity.

Aspect 25. The method of any one of Aspects 21 to 23, wherein the threshold is fixed.

Aspect 26. The method of any one of Aspects 21 to 25, wherein the cell metric comprises a reference Layer 1 (L1) reference signal received power (RSRP) measurement of the cell based on a synchronization signal block (SSB).

Aspect 27. The method of any one of Aspects 21 to 25, wherein the cell metric comprises a reference Layer 3 (L3) reference signal received power (RSRP) measurement of the cell based on a synchronization signal block (SSB).

Aspect 28. The method of any one of Aspects 21 to 27, wherein the UE is configured for receiving layer 1 measurement data for candidate cells.

Aspect 29. An apparatus for wireless communications, comprising: at least one memory; and at least one processor coupled to at least one memory and configured to: determine whether a relaxed measurement criterion for a good cell-quality condition is satisfied based on a cell metric of a cell, a threshold associated with a downlink radio link quality, and an offset parameter; and based on the relaxed measurement criterion for the good cell-quality condition being satisfied, perform a selective layer 1 (L1) measurement for the cell, the L1 measurement being associated with transitioning the apparatus from communicating with the cell to communicating with a candidate cell.

Aspect 30. The apparatus of Aspect 29, wherein the selective L1 measurement comprises one of suspending L1 measurements for the cell or reducing a frequency of the L1 measurements for the cell.

Aspect 31. The apparatus of any one of Aspects 29 or 30, wherein, to determine the relaxed measurement criterion for the good cell-quality condition is satisfied, the at least one processor is configured to: determine the cell metric of the cell is greater than a sum of the threshold associated with the downlink radio link quality and the offset parameter.

Aspect 32. The apparatus of any one of Aspects 29 to 31, wherein the threshold is configured by a network entity.

Aspect 33. The apparatus of any one of Aspects 29 to 31, wherein the threshold is fixed.

Aspect 34. The apparatus of any one of Aspects 29 to 33, wherein the cell metric comprises a reference Layer 1 (L1) reference signal received power (RSRP) measurement of the cell based on a synchronization signal block (SSB).

Aspect 35. The apparatus of any one of Aspects 29 to 33, wherein the cell metric comprises a reference Layer 3 (L3) reference signal received power (RSRP) measurement of the cell based on a synchronization signal block (SSB).

Aspect 36. The apparatus of any one of Aspects 29 to 35, wherein the apparatus is configured for receiving layer 1 measurement data for candidate cells.

Aspect 37. A non-transitory computer-readable medium having stored thereon instructions that, when executed by one or more processors, cause the one or more processors to perform operations according to any one of Aspects 21 to 28.

Aspect 38. An apparatus for performing wireless communication, the apparatus including one or more means for performing operations according to any one of Aspects 21 to 28.

Aspect 39. A method of wireless communications performed by a user equipment (UE), the method comprising: determining whether a relaxed measurement criterion for a bad candidate-cell condition is satisfied based on comparing a threshold value to at least one of a cell metric of a candidate cell or a cell metric of a serving cell; and based on the relaxed measurement criterion for the bad candidate-cell condition being satisfied, performing a selective layer 1 (L1) measurement for at least one of the serving cell or the candidate cell, the L1 measurement being associated with transitioning the UE from communicating with the serving cell to communicating with at least one candidate cell.

Aspect 40. The method of Aspect 39, wherein the selective L1 measurement comprises one of suspending L1 measurements for at least one of the serving cell or the candidate cell or reducing a frequency of the L1 measurements for at least one of the serving cell or the candidate cell.

Aspect 41. The method of any one of Aspects 39 or 40, wherein determining the relaxed measurement criterion for the bad candidate-cell condition is satisfied comprises: determining a difference of the cell metric of the serving cell from the cell metric of the serving cell is less than the threshold value.

Aspect 42. The method of any one of Aspects 39 or 40, wherein determining the relaxed measurement criterion for the bad candidate-cell condition is satisfied comprises: determining the cell metric of the candidate cell is less than the threshold value.

Aspect 43. The method of any one of Aspects 39 to 42, wherein the cell metric of the candidate cell comprises a current Layer 1 (L1) reference signal received power (RSRP) measurement of the candidate cell based on a first synchronization signal block (SSB) and wherein the cell metric of the serving cell comprises a current layer 1 RSRP measurement of the serving cell based on a second SSB.

Aspect 44. The method of any one of Aspects 39 to 42, wherein the cell metric of the candidate cell comprises a current Layer 3 (L3) reference signal received power (RSRP) measurement of the candidate cell based on a first synchronization signal block (SSB) and wherein the cell metric of the serving cell comprises a current layer 3 RSRP measurement of the serving cell based on a second SSB.

Aspect 45. An apparatus for wireless communication, comprising: at least one memory; and at least one processor coupled to at least one memory and configured to: determine whether a relaxed measurement criterion for a bad candidate-cell condition is satisfied based on comparing a threshold value to at least one of a cell metric of a candidate cell or a cell metric of a serving cell; and based on the relaxed measurement criterion for the bad candidate-cell condition being satisfied, perform a selective layer 1 (L1) measurement for at least one of the serving cell or the candidate cell, the L1 measurement being associated with transitioning the apparatus from communicating with the serving cell to communicating with at least one candidate cell.

Aspect 46. The apparatus of Aspect 45, wherein the selective L1 measurement comprises one of suspending L1 measurements for at least one of the serving cell or the candidate cell or reducing a frequency of the L1 measurements for at least one of the serving cell or the candidate cell.

Aspect 47. The apparatus of any one of Aspects 45 or 46, wherein, to determine the relaxed measurement criterion for the bad candidate-cell condition is satisfied, the at least one processor is configured to: determine a difference of the cell metric of the serving cell from the cell metric of the serving cell is less than the threshold value.

Aspect 48. The apparatus of any one of Aspects 45 or 46, wherein, to determine the relaxed measurement criterion for the bad candidate-cell condition is satisfied, the at least one processor is configured to: determine the cell metric of the candidate cell is less than the threshold value.

Aspect 49. The apparatus of any one of Aspects 45 to 48, wherein the cell metric of the candidate cell comprises a current Layer 1 (L1) reference signal received power (RSRP) measurement of the candidate cell based on a first synchronization signal block (SSB) and wherein the cell metric of the serving cell comprises a current layer 1 RSRP measurement of the serving serving cell based on a second SSB.

Aspect 50. The apparatus of any one of Aspects 45 to 48, wherein the cell metric of the candidate cell comprises a current Layer 3 (L3) reference signal received power (RSRP) measurement of the candidate cell based on a first synchronization signal block (SSB) and wherein the cell metric of the serving cell comprises a current layer 3 RSRP measurement of the serving cell based on a second SSB.

Aspect 51. A non-transitory computer-readable medium having stored thereon instructions that, when executed by one or more processors, cause the one or more processors to perform operations according to any one of Aspects 39 to 44.

Aspect 52. An apparatus for wireless communications, the apparatus including one or more means for performing operations according to any one of Aspects 39 to 44.

Aspect 53. A method of providing wireless communication performed by a user equipment (UE), the method comprising: determining one or more cells in a triggering evaluation; determining a cell metric type associated with the triggering evaluation; determining, according to the cell metric type, whether a triggering condition exists; and based on determining the triggering condition exists, performing a selective layer 1 (L1) measurement.

Aspect 54. The method of Aspect 53, wherein the selective L1 measurement comprises one of suspending L1 measurements based on a relaxed measurement criterion for low mobility being fulfilled or reducing a frequency of L1 measurement based on the relaxed measurement criterion being fulfilled.

Aspect 55. The method of Aspect 53, wherein determining one or more cells in the triggering evaluation further comprises determining a plurality of cells for use in the triggering evaluation.

Aspect 56. The method of any one of Aspects 53 to 55, wherein determining one or more cells in the triggering evaluation is based on a fixed rule for serving cells or candidate cells.

Aspect 57. The method of any one of Aspects 53 to 55, wherein determining one or more cells in the triggering evaluation is based on a network entity configuring serving cells or candidate cells.

Aspect 58. The method of any one of Aspects 53 to 55, wherein determining one or more cells in the triggering evaluation is based on any or all of serving cells or candidate cells, including a primary serving cell (PCell) or not including the PCell.

Aspect 59. The method of any one of Aspects 53 to 58, wherein the cell metric type comprises one or more of: (1) a metric related to a cell level; (2) a layer 3 (L3) cell quality; (3) a L3 SS-RSRP (synchronization signal-reference signal received power); (4) a L3 SS-SINR (synchronization signal-signal interference noise ratio); (5) an L1 cell quality; (6) a L1-SINR; (7) a L1-RSRP; (8) an cell-average value; (9) a top X beams/reference signal (RS) in the cell; (10) all or at least one RS; (11) a beam failure detection RS in the cell; (12) a multiple transmit/receive point (mTRP); (13) a mTRP in which two transmission configuration indicators (TCIs) are indicated including a quasi-colocation (QLC) RS of the two TCIs or at least one indicated TCI.

Aspect 60. The method of any one of Aspects 53 to 59, wherein the triggering condition comprises one or more of a low mobility condition, a serving cell too good condition, a serving cell too good plus a candidate cell to bad condition.

Aspect 61. The method of Aspect 60, wherein the low mobility condition comprises a scenario where one or multiple serving/candidate cells are in low mobility and the serving cell too good condition comprises a scenario where the serving cell is too good plus one or multiple serving/candidate cells are too good.

Aspect 62. The method of any one of Aspects 60 to 61, wherein the serving cell too good plus the candidate cell to bad condition comprises one of a scenario where the serving cell is too good plus all candidate cells are too bad or a scenario where the serving cell is too good plus an individual cell is too bad.

Aspect 63. The method of any one of Aspects 53 to 62, wherein the selective L1 measurement comprises one or more of: (1) skipping a L1 measurement; (2) reducing a L1 measurement frequency; (3) skipping the L1 measurement or reducing the L1 measurement frequency for a single cell that reaches the triggering condition; (4) skipping the L1 measurement or reducing the L1 measurement frequency for all cells when a single cell reaches the triggering condition; (5) skipping the L1 measurement or reducing the L1 measurement frequency for all cells when all cells reach the triggering condition.

Aspect 64. An apparatus for performing wireless communication, comprising: at least one memory; and at least one processor coupled to at least one memory and configured to: determine one or more cells in a triggering evaluation; determine a cell metric type associated with the triggering evaluation; determine, according to the cell metric type, whether a triggering condition exists; and based on determining the triggering condition exists, perform a selective layer 1 (L1) measurement.

Aspect 65. The apparatus of Aspect 64, wherein the selective L1 measurement comprises one of suspending L1 measurements based on a relaxed measurement criterion for low mobility being fulfilled or reducing a frequency of L1 measurement based on the relaxed measurement criterion being fulfilled.

Aspect 66. The apparatus of Aspect 64, wherein determining one or more cells in the triggering evaluation further comprises determining a plurality of cells for use in the triggering evaluation.

Aspect 67. The apparatus of any one of Aspects 64 to 66, wherein determining one or more cells in the triggering evaluation is based on a fixed rule for serving cells or candidate cells.

Aspect 68. The apparatus of any one of Aspects 64 to 66, wherein determining one or more cells in the triggering evaluation is based on a network entity configuring serving cells or candidate cells.

Aspect 69. The apparatus of any one of Aspects 64 to 66, wherein determining one or more cells in the triggering evaluation is based on any or all of serving cells or candidate cells, including a primary serving cell (PCell) or not including the PCell.

Aspect 70. The apparatus of any one of Aspects 64 to 69, wherein the cell metric type comprises one or more of: (1) a metric related to a cell level; (2) a layer 3 (L3) cell quality; (3) a L3 SS-RSRP (synchronization signal-reference signal received power); (4) a L3 SS-SINR (synchronization signal-signal interference noise ratio); (5) an L1 cell quality; (6) a L1-SINR; (7) a L1-RSRP; (8) an cell-average value; (9) a top X beams/reference signal (RS) in the cell; (10) all or at least one RS; (11) a beam failure detection RS in the cell; (12) a multiple transmit/receive point (mTRP); (13) a mTRP in which two transmission configuration indicators (TCIs) are indicated including a quasi-colocation (QLC) RS of the two TCIs or at least one indicated TCI.

Aspect 71. The apparatus of any one of Aspects 64 to 70, wherein the triggering condition comprises one or more of a low mobility condition, a serving cell too good condition, a serving cell too good plus a candidate cell to bad condition.

Aspect 72. The apparatus of Aspect 71, wherein the low mobility condition comprises a scenario where one or multiple serving/candidate cells are in low mobility and the serving cell too good condition comprises a scenario where the serving cell is too good plus one or multiple serving/candidate cells are too good.

Aspect 73. The apparatus of any one of Aspects 71 to 72, wherein the serving cell too good plus the candidate cell to bad condition comprises one of a scenario where the serving cell is too good plus all candidate cells are too bad or a scenario where the serving cell is too good plus an individual cell is too bad.

Aspect 74. The apparatus of any one of Aspects 64 to 73, wherein the selective L1 measurement comprises one or more of: (1) skipping a L1 measurement; (2) reducing a L1 measurement frequency; (3) skipping the L1 measurement or reducing the L1 measurement frequency for a single cell that reaches the triggering condition; (4) skipping the L1 measurement or reducing the L1 measurement frequency for all cells when a single cell reaches the triggering condition; (5) skipping the L1 measurement or reducing the L1 measurement frequency for all cells when all cells reach the triggering condition.

Aspect 75. A non-transitory computer-readable medium having stored thereon instructions that, when executed by one or more processors, cause the one or more processors to perform operations according to any one of Aspects 53 to 63.

Aspect 76. An apparatus for wireless communications, the apparatus including one or more means for performing operations according to any one of Aspects 53 to 63.

1. A method of wireless communications performed by a user equipment (UE), the method comprising:
determining whether a relaxed measurement criterion for low mobility is satisfied based on at least one reference measurement of a cell and at least one current measurement of the cell; and
based on the relaxed measurement criterion for low mobility being satisfied, performing a selective layer 1 (L1) measurement for the cell, the L1 measurement being associated with transitioning the UE from communicating with the cell to communicating with a candidate cell.

2. The method of claim 1, wherein the selective L1 measurement comprises one of suspending L1 measurements for the cell or reducing a frequency of the L1 measurements for the cell.

3. The method of claim 1, wherein determining the relaxed measurement criterion comprises comparing a difference of the at least one current measurement from the at least one reference measurement to a threshold value.

4. The method of claim 1, wherein the at least one reference measurement comprises a reference Layer 1 (L1) reference signal received power (RSRP) measurement of the cell based on a synchronization signal block (SSB), and wherein the at least one current measurement comprises a current L1 RSRP measurement of the cell based on an SSB.

5. The method of claim 1, wherein the at least one reference measurement comprises a reference Layer 3 (L3) reference signal received power (RSRP) measurement of the cell based on a first synchronization signal block (SSB), and wherein the at least one current measurement comprises a current L3 RSRP measurement of the cell based on a second SSB.

6. (canceled)

7. The method of claim 1, wherein a current measurement for the cell is set as a reference measurement for the cell for the relaxed measurement criterion based on at least one of determining the relaxed measurement criterion, a difference of the reference measurement from the current measurement being greater than 0, or the relaxed measurement criterion not being met for a period of time.

8. (canceled)

9. The method of claim 1, wherein the UE is configured to receive layer 1 measurement data for candidate cells.

10-20. (canceled)

21. A method of wireless communications performed by a user equipment (UE), the method comprising:
determining whether a relaxed measurement criterion for a good cell-quality condition is satisfied based on a cell metric of a cell, a threshold associated with a downlink radio link quality, and an offset parameter; and
based on the relaxed measurement criterion for the good cell-quality condition being satisfied, performing a selective layer 1 (L1) measurement for the cell, the L1 measurement being associated with transitioning the UE from communicating with the cell to communicating with a candidate cell.

22. The method of claim 21, wherein the selective L1 measurement comprises one of suspending L1 measurements for the cell or reducing a frequency of the L1 measurements for the cell.

23. The method of claim 21, wherein determining the relaxed measurement criterion for the good cell-quality condition is satisfied comprises:
determining the cell metric of the cell is greater than a sum of the threshold associated with the downlink radio link quality and the offset parameter.

24. The method of claim 21, wherein the threshold is configured by a network entity.

25. The method of claim 21, wherein the threshold is fixed.

26. The method of claim 21, wherein the cell metric comprises a reference Layer 1 (L1) reference signal received power (RSRP) measurement of the cell based on a synchronization signal block (SSB).

27. The method of claim 21, wherein the cell metric comprises a reference Layer 3 (L3) reference signal received power (RSRP) measurement of the cell based on a synchronization signal block (SSB).

28. The method of claim 21, wherein the UE is configured for receiving layer 1 measurement data for candidate cells.

29-38. (canceled)

39. A method of wireless communications performed by a user equipment (UE), the method comprising:
determining whether a relaxed measurement criterion for a bad candidate-cell condition is satisfied based on comparing a threshold value to at least one of a cell metric of a candidate cell or a cell metric of a serving cell; and
based on the relaxed measurement criterion for the bad candidate-cell condition being satisfied, performing a selective layer 1 (L1) measurement for at least one of the serving cell or the candidate cell, the L1 measurement being associated with transitioning the UE from communicating with the serving cell to communicating with at least one candidate cell.

40. The method of claim 39, wherein the selective L1 measurement comprises one of suspending L1 measurements for at least one of the serving cell or the candidate cell or reducing a frequency of the L1 measurements for at least one of the serving cell or the candidate cell.

41. The method of claim 39, wherein determining the relaxed measurement criterion for the bad candidate-cell condition is satisfied comprises:
determining a difference of the cell metric of the serving cell from the cell metric of the serving cell is less than the threshold value.

42. The method of claim 39, wherein determining the relaxed measurement criterion for the bad candidate-cell condition is satisfied comprises:
determining the cell metric of the candidate cell is less than the threshold value.

43. The method of claim 39, wherein the cell metric of the candidate cell comprises a current Layer 1 (L1) reference signal received power (RSRP) measurement of the candidate cell based on a first synchronization signal block (SSB) and wherein the cell metric of the serving cell comprises a current layer 1 RSRP measurement of the serving cell based on a second SSB.

44. The method of claim 39, wherein the cell metric of the candidate cell comprises a current Layer 3 (L3) reference signal received power (RSRP) measurement of the candidate cell based on a first synchronization signal block (SSB) and wherein the cell metric of the serving cell comprises a current layer 3 RSRP measurement of the serving cell based on a second SSB.

45-52. (canceled)

53. A method of providing wireless communication performed by a user equipment (UE), the method comprising:
determining one or more cells in a triggering evaluation;
determining a cell metric type associated with the triggering evaluation;
determining, according to the cell metric type, whether a triggering condition exists; and
based on determining the triggering condition exists, performing a selective layer 1 (L1) measurement.

54. The method of claim 53, wherein the selective L1 measurement comprises one of suspending L1 measurements based on a relaxed measurement criterion for low mobility being fulfilled or reducing a frequency of L1 measurement based on the relaxed measurement criterion being fulfilled.

55. The method of claim 53, wherein determining one or more cells in the triggering evaluation further comprises determining a plurality of cells for use in the triggering evaluation.

56. The method of claim 53, wherein determining one or more cells in the triggering evaluation is based on a fixed rule for serving cells or candidate cells.

57. The method of claim 53, wherein determining one or more cells in the triggering evaluation is based on a network entity configuring serving cells or candidate cells.

58. The method of claim 53, wherein determining one or more cells in the triggering evaluation is based on any or all of serving cells or candidate cells, including a primary serving cell (PCell) or not including the PCell.

59. The method of claim 53, wherein the cell metric type comprises one or more of:
(1) a metric related to a cell level;
(2) a layer 3 (L3) cell quality;
(3) a L3 SS-RSRP (synchronization signal-reference signal received power);
(4) a L3 SS-SINR (synchronization signal-signal interference noise ratio);
(5) an L1 cell quality;
(6) a L1-SINR;
(7) a L1-RSRP;
(8) an cell-average value;
(9) a top X beams/reference signal (RS) in the cell;
(10) all or at least one RS;
(11) a beam failure detection RS in the cell;
(12) a multiple transmit/receive point (mTRP);
(13) a mTRP in which two transmission configuration indicators (TCIs) are indicated including a quasi-colocation (QLC) RS of the two TCIs or at least one indicated TCI.

60. The method of claim 53, wherein the triggering condition comprises one or more of a low mobility condition, a serving cell too good condition, a serving cell too good plus a candidate cell to bad condition.

61-62. (canceled)

63. The method of claim 53, wherein the selective L1 measurement comprises one or more of:
(1) skipping a L1 measurement;
(2) reducing a L1 measurement frequency;
(3) skipping the L1 measurement or reducing the L1 measurement frequency for a single cell that reaches the triggering condition;
(4) skipping the L1 measurement or reducing the L1 measurement frequency for all cells when a single cell reaches the triggering condition;
(5) skipping the L1 measurement or reducing the L1 measurement frequency for all cells when all cells reach the triggering condition.

64-76. (canceled)
